(19) United States
(12) Patent Application Publication
(10) Pub. No.: US 2025/0075775 A1
(43) Pub. Date: Mar. 6, 2025

(54) METHOD AND SYSTEM FOR THE TRANSFORMATION OF CIRCULAR TO NON-CIRCULAR ROTARY MOTION

(71) Applicant: Building Machines, Inc., Hudson, MA (US)

(72) Inventors: Jeremy Samuel De Bonet, Southborough, MA (US); Nicholas Charles McMahon, Bolton, MA (US); Thomas Elisha Battistini, Methuen, MA (US)

(21) Appl. No.: 18/707,857

(22) PCT Filed: Oct. 1, 2021
(86) PCT No.: PCT/US2021/053123

§ 371 Date: May 6, 2024

Related U.S. Application Data
(60) Provisional application No. 63/086,941, filed on Oct. 2, 2020.

(51) Int. Cl. F16H 21/02; F16H 21/12

(52) U.S. Cl. CPC F16H 21/02; F16H 21/12

(57) ABSTRACT

Systems and methods for converting ordinary circular rotary motion into any non-circular motion that can be defined as a non-overlapping proper function in polar coordinates are provided. Embodiments disclosed teach how to make and use devices that can use the rotary output from motors, turbines and other sources of circular rotary motion to create motion that follows square, rectangular, triangular, or other useful paths. Such devices can be usefully employed as a replacement for conventional devices in applications where the desired path or area of coverage is not circular, including air-moving (fans), air-energy capture (turbines), surface finishing (sanding, polishing, cleaning), among many others.

### CROSS-REFERENCE TO RELATED APPLICATION(S)

This application claims a benefit of priority under 35 U.S.C. § 119 (e) from U.S. Provisional Application No. 63/086,941, filed Oct. 2, 2020, entitled “METHOD AND SYSTEM FOR THE TRANSFORMATION OF CIRCULAR TO NON-CIRCULAR ROTARY MOTION,” which is fully incorporated by reference herein for all purposes.

### TECHNICAL FIELD

This disclosure relates generally to mechanical and electromechanical devices. In particular, this disclosure relates to systems and methods for converting circular rotary motion into non-circular rotary motion.

### BACKGROUND

Many methods of generating motive power create circular rotary motion. Examples include electric motors, engines, water wheels, wind and steam turbines, etc. Attaching some working element to that circular motion is the fundamental design principle behind many machines, tools, and appliances.

One application area is in the design of axial-flow fans. Axial-flow fans have a series of fixed-length blades that are attached to a circularly rotating shaft which force air to move parallel to the direction of the shaft. The blades sweep out a circular area, and it is in that area that the blades apply force to the air. However, in many applications, these fans are used in a square or rectangular area. Examples include a box fan used in a window, a fan used in a square air duct, a computer fan cooling a rectangular component, etc. In such applications, the circular area swept out by the blades is smaller than the target area (e.g., the area of the duct, etc.), and as a result, the fan does not move as much air as it would if the blades swept out the full target area.

Another application area of particular interest is in circular devices which are applied to rectilinear areas for purposes of a finishing or cleaning application. These devices are effective in open areas, but cannot get into corners. For example, consider a rotary floor polisher which is unable to polish in the corners of a room. Similar constraints are found in uses of other devices such as rotary sanders, power trowels, and brushes used by robotic vacuum cleaners.

Therefore, there is a need for techniques to convert circular rotary motion into non-circular rotary motion for applications in a broad range of mechanical and electromechanical devices including, for example, tools, fans, power generation, surface finishing, among many others.

### SUMMARY

Systems and methods are described for converting circular rotary motion into non-circular rotary motion.

One embodiment describes an apparatus including a rotatable shaft, a first armature member coupled to the rotatable shaft, a second armature member movably coupled to the first armature member, wherein the second armature member is radially movable along the first armature member (i.e., a sliding joint), a guide member disposed around the rotatable shaft defining a non-circular path, and a bearing coupled to the second armature member, the bearing being configured to engage the guide member as the first and second armatures rotate with the rotatable shaft causing the second armature member to follow the non-circular path defined by the guide member.

Another embodiment provides a method of converting circular rotary motion into non-circular rotary motion, the method including coupling a first armature member to a rotatable shaft, movably coupling a second armature member to the first armature member, wherein the second armature member is radially movable along the first armature member, rotating the first and second armature members, and as the first and second armature members are rotated, adjusting the effective length of the first and second armature members to cause an end of the second armature member to move in a desired non-circular path.

Another embodiment provides an apparatus for converting circular rotary motion into non-circular rotary motion including a guide member disposed around the rotatable shaft defining a non-circular path, a plurality of armature assemblies coupled to the rotatable shaft, wherein each of the armature assemblies further includes a first armature member coupled to the rotatable shaft, a second armature member movably coupled to the first armature member, wherein the second armature member is radially movable along an axis of the first armature member, a bearing coupled to the second armature member, the bearing being configured to engage the guide member as the first and second armatures rotate with the rotatable shaft causing the second armature member to follow the non-circular path defined by the guide member, and a plurality of functional components, each functional component coupled to the second armature member of one of the plurality of armature assemblies.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE FIGURES

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 is a schematic representation of a system and method that converts circular rotary motion into non-circular rotary motion.

FIGS. 2-4 are diagrammatic representations of exemplary non-circular motions.

FIG. 5 is an isometric diagrammatic representation of a mechanical embodiment of a method used to sweep a square path by transforming circular rotary motion.

FIGS. 6A-6F show views of fan blades sweeping a square path.

FIG. 7 is a block diagram depicting an armature controlled by a controller and actuator.

FIG. 8 is a simplified partial view of a power trowel utilizing methods for converting circular rotary motion into non-circular rotary motion.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions and/or rearrangements within the spirit and/or scope of the underlying inventive concept will become apparent to those skilled in the art from this disclosure.

Generally, the present disclosure describes systems and methods that convert circular rotary motion into non-circular rotary motion, and applies to the design of a broad range of mechanical and electromechanical devices including tools, fans, power generation, surface finishing/cleaning, among many machines. While these applications of this method are quite general, this disclosure also discusses important applications relating to the design of air-moving fans for square or rectangular ducts or windows. Other applications discussed in the present disclosure relate to sanding, troweling, cleaning, and similar finishing applications where the area to be finished or cleaned is rectilinear.

The various applications mentioned above that utilize devices to convert circular rotary motion to non-circular rotary motion can take on many different forms and be powered by many different sources. Examples of prime movers that can provide a source of rotary motion include electric motors, engines, wind turbines, steam turbines, water wheels, animal/human driven prime movers, etc. Other sources may also be used.

In some embodiments, one or more armatures are attached to a circularly moving shaft that is powered by the prime mover. In some examples, the armatures are each a single component which is able to change in length through stretching, expansion, scissoring, or other means. In other examples, the armatures are each comprised of an assembly comprising two or more components, one of which is affixed to the shaft, and each of the next components can move radially with respect to the rotating axis of the prime mover, along the preceding component of the assembly.

In some embodiments, the armature assembly includes structures or components that perform a useful function when moved. For example, one useful function performed by the armature(s) is moving air, such as with a fan. Another useful function performed by the armature is moving water, for example, for pumping water through a rectangular channel or harvesting energy from a rectangular culvert. Another useful function performed by the armature is use with flashing lights. For example, devices commonly known as “3D hologram fan displays” use LED lights mounted to a rotating fan to produce a round video display. Using the techniques described herein, a similar video display can be created having a rectangular shape, with the aspect ratios used by standard video formats such as 4:3, 16:9, or 21:9 (as well as other aspect ratios or non-rectangular shapes). In addition, with the present method, multiple displays can be used together to create larger contiguous displays. Another useful function performed by the armature is sanding, cleaning, or polishing. Another useful function performed by the armature is troweling, floating, and or smoothing.

In some embodiments, the length of an armature is dynamically adjusted via electronic actuation under the computer control such that as the angle of the armature changes as a result of the circular motion from the shaft to which it is attached, and the length of the armature is adjusted so that the moving end of the armature extends or contracts to match the desired non-circular rotary motion.

In some embodiments an armature has a bearing attached somewhere along its moving end. The bearing can take on any desired form, such as a wheel mounted on a shaft, a peg, a protrusion, or other path-following mechanism. In examples in which the armature has a bearing (or equivalent), the bearing may ride on an outer guide which prevents the armature from extending beyond a set distance established by the shape of the guide at every angle. Centrifugal force from the rotation of the armature pushes the armature radially outward until its radial motion is prevented by the bearing pressing against the guide.

In other embodiments in which the armature has a bearing, the bearing rides within a track which completely defines the radial movement of the end of the armature as the armature rotates with the circular motion being generated by the shaft. In such embodiments the track applies both inward and outward radial force to the bearing attached to the armature, causing the armature to extend and retract and follow a desired non-circular motion.

Reference is now made in detail to the exemplary embodiments of the disclosure, examples of which are illustrated in the accompanying drawings. Wherever possible, like numerals will be used throughout the drawings to refer to like and corresponding parts (elements) of the various drawings.

The present method and invention provide for mechanical and electromechanical mechanisms which can convert circular rotary motion to non-circular rotary motion, and can be useful within many devices and machines used across a wide variety of applications.

Some embodiments using this method attach one or more radially expandable armatures to a circularly rotating shaft or other source of circular rotary motion. As the armatures spin, their length changes as directed by electromechanical or mechanical means so that their length at each angle of rotation is altered so that the tips of the armature sweep out a desired non-circular path.

One preferred method of controlling the armature length is to affix a bearing to the extendable portion of the armature, and place that bearing within a guiding track which has been constructed so that the distance from the track to the desired path for the tip of the armature, is, at each angle of rotation, set so as to be equal to the distance from the bearing to the tip of the armature.

Other methods of controlling the armature length include only constraining the outward motion of the armature using a bearing and an outer guide, and allowing the centrifugal force from rotation to push the armature bearing against the guide. One particularly simple implementation of this approach is to put the bearing at the outer tip of the armature, and create a guide which is exactly the desired shape. While simple, however, this approach requires the bearing move at high speed, relative to the prior method which can have the bearing and track closer to the center of rotation where speeds are lower.

Yet another method of controlling the armature length is to use an electronic actuator under the control of a computer or other electronic system. Such a system may involve programming a digital equivalent of the mechanical tracks and guides described above, and is within the ability of a person of ordinary skill in the art. Other implementations could involve materials or devices whose electrical resistance varies with angle, for example by altering material thickness with angle. Still other implementations could change the armature length in response to input from a sensor device, which, for example, could be used to contract the armature to avoid an obstacle which would otherwise be in its path at a longer extension.

The generated non-circular motion can take on an infinite variety of paths, though there are some limitations. With the present method, the non-circular motion should be representable by a proper non-negative-valued polar function. Meaning, that if the motion were plotted on a polar graph with the axes (r, Θ) representing distance from the origin and angle around the origin, respectively, the path could be represented by a function r=f(Θ), which yields only a single non-negative value for each value of e. However, the origin need not be placed at the center of the desired motion, and in some instances motions can be created only if the origin is not at the motion's center (see FIG. 4 for examples).

In the figures, the motions are shown in a counterclockwise direction, however, the method and implementations are identical if the direction of rotation is reversed.

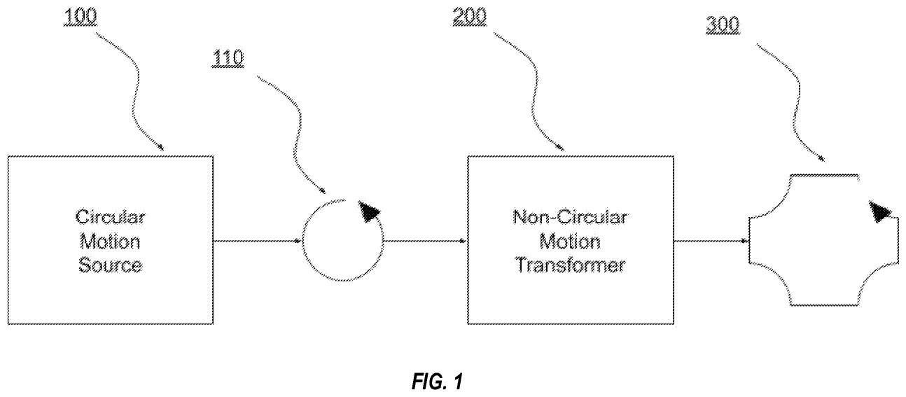

FIG. 1 is a schematic representation of an exemplary embodiment of a system and method that converts circular rotary motion into non-circular rotary motion. As shown in FIG. 1, a circular motion source 100 (such as the examples described above) generates circular rotary motion (represented by arrow 110). A device which implements the conversion (an example is described in detail below) acts as a non-circular motion transformer 200, resulting in a motion 300 which is non-circular.

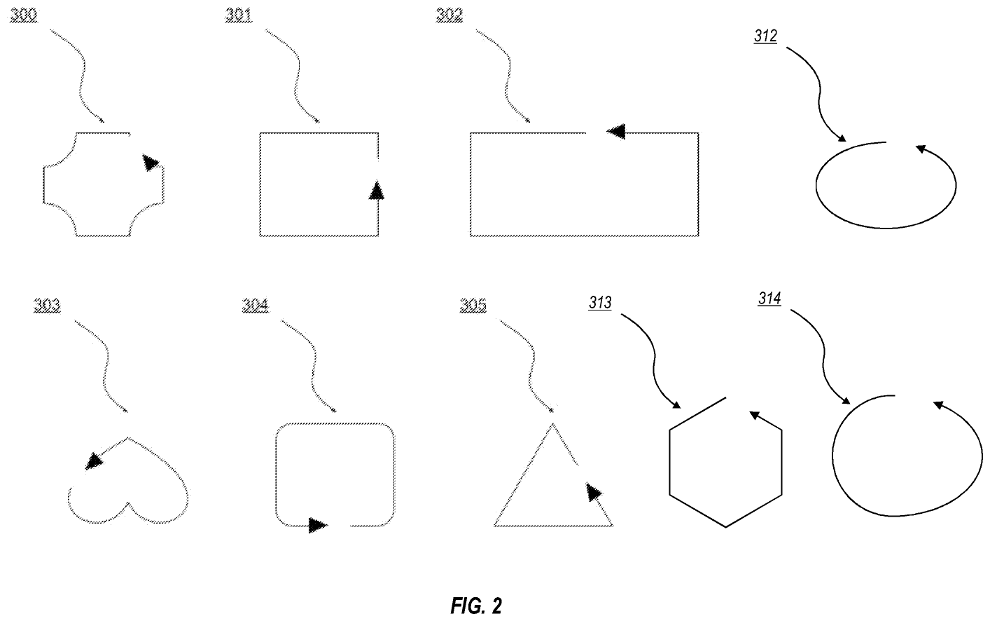

As discussed above, the disclosed techniques can convert circular rotary motion into any desired non-circular rotary motion, within the capabilities of the specific implementation. FIG. 2 is a diagrammatic representation of eight exemplary non-circular motions (represented by arrows 300, 301, 302, 303, 304, 305, 312, 313, 314) which the present method can be used to create by converting circular rotary motion. Motions 301, 302, 304, 305, and 313 are shaped generally as polygons, including shapes such as a square, rectangle, triangle, hexagon, etc., including an example (304) with rounded corners. Motion 312 is shaped as an oval. Motion 314 is shaped as an ovoid (i.e., “egg-shaped”). Motions 301, 302 and 304 in may prove to be especially useful as they allow motions that are compatible with the rectilinear nature of many other man made constructs. In each of these examples, the input circular rotary motion can be centered at or near the center of the target non-circular motion.

FIG. 3 is a diagrammatic representation of three examples of irregular non-circular motions (represented by arrows 306, 307, 308) which the present method can also be used to create by converting circular rotary motion. Motion 306 is representative of motions which are asymmetric. Motion 307 is representative of motions with differing angles and lengths. Motion 308 is representative of a large class of convex shapes. As in FIG. 2, in each of these examples the input circular rotary motion can also be centered at or near the center of the target non-circular motion.

FIG. 4 is a diagrammatic representation of three examples of non-circular motions (represented by arrows 309, 310, 311) which the present method can create, but which may require that the source of circular rotary motion 200 is not at the center of the desired motion. In exemplary motions 310 and 311, the source of circular motion 200 is within the desired non-circular motion, but is offset from its center to enable a polar functional representation of the desired motion. In example 309, the circular motion source may be outside the path of the desired motion, and this path is made possible by considering negative values for r from the polar function f(Θ). Motion 309 can also be created with the rotation point on the diameter line with only non-negative lengths.

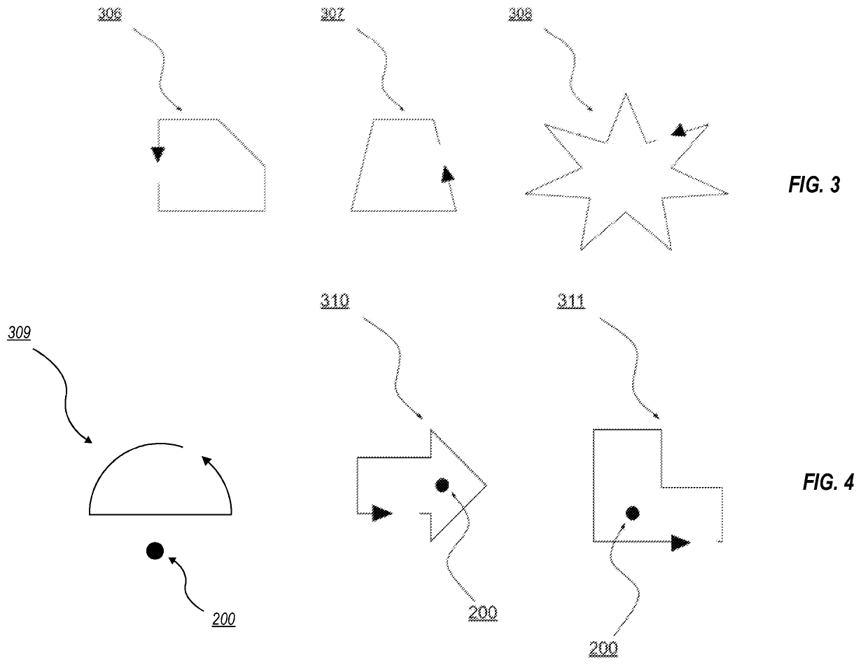

FIG. 5 is an isometric diagrammatic representation of a mechanical embodiment of the present method used to sweep out a square path 400, by transforming circular rotary motion 110. In this example, a two part armature assembly comprises an outer armature portion 320, which can freely slide radially relative to an inner armature portion 330.

In the example shown in FIG. 5, a protrusion 321 of the outer armature 320 slides within a channel 330 of the inner armature 330, creating a sliding joint, such that the inner and outer armatures 330 and 320 can slide axially with respect to each other, while maintaining a rigid connection perpendicular to the sliding axis. Other sliding joint configurations can also be utilized, as one skilled in the art would understand.

The inner armature portion 330 is attached to a source of circular rotary motion 100. As discussed above, the source of circular rotary motion 100 may be powered by any desired prime mover to rotate a shaft, thus causing the two part armature to rotate, as illustrated by circular rotary motion 110. In this example, affixed to the outer armature portion 320 is a bearing 340 (shown in dashed lines), which rides within a guiding track 350. In the example shown in FIG. 5, the guiding track is disposed near the midpoint of the two part armature. In other examples, the guiding track can be disposed closer to or farther from the axis of rotation. In another example, the guiding track and mating bearing can be disposed at the end of the outer armature.

The bearing 340 may be comprised of a non-rotating pin or peg or other protrusion that engages the inside surfaces of the guiding track 350, or a rotatable bearing, as desired. Depending on the application of the device, a designer may choose one type of bearing or another depending on factors such as rotational speed, friction, guiding track shapes, etc., as one skilled in the art would understand. In other examples, the guiding track 350 could be a single sided track (e.g., just the outer surface of the track shown in FIG. 5), thus forming the desired shape, without the matching inner surface. In this example, the bearing 340 would be biased outward against the guiding track by centrifugal force, as the armature rotates. In this example, the guiding track, armature, and bearing could be disposed on the same plane (thus, not requiring a bearing/protrusion extending from the armature. In other examples, a spring(s) can bias the bearing inward toward an outward-facing guiding track, such that as the armature rotates, the guiding track pushes the bearing (and thus, the armature) outward. In other examples, the guiding track 350 could comprise a removable and replaceable plate, which can be removed and replaced by another plate, having a guiding track with a different configuration, thus enabling a device that can selectively create different shaped non-circular rotary motions.

As the inner armature portion 330 rotates due to circular motion 110 from circular motion source 100, the outer armature portion 320 is moved radially inward and outward (relative to the inner armature portion 330) by bearing 340 riding in guiding track 350. Guiding track 350 is designed so that its distance to the desired motion 400 along every angle from the center of motion at the source of circular motion 100 is approximately equal to the fixed distance from the bearing 340 to the outermost edge of the moving outer armature portion 320. In other words, as the two part armature rotates about the source of circular rotary motion 100, the outer armature portion 320 will side in and out, decreasing and increasing the total length of the two part armature, such that the outermost edge of the outer armature portion 320 will follow the desired, non-circular rotational path 400, which in this example, approximates a square path.

In some embodiments, the armatures can also be movable in an axial direction relative to the plane of rotation of the armatures. For example, for a fan blade, trowel blade, etc., the second armature member can be moved (e.g., rotated) to change the pitch of the blade. In other examples, a portion of the second armature (or a component coupled to the armature) can be movably coupled to the remainder of the second armature. As the armatures are rotated, the movable portion can be moved in an axial direction relative to the plane of rotation of the armatures to achieve a desired result. This movement can be achieved in a mechanical or electromechanical manner (or in any other manner), as one skilled in the art would understand.

As discussed in more detail below, various components can be coupled to the outer armature portion 320 to create desired tools or devices. Exemplary components may include fan blades, turbines blades, sanding/cleaning/polishing members, troweling/floating/smoothing members, etc.

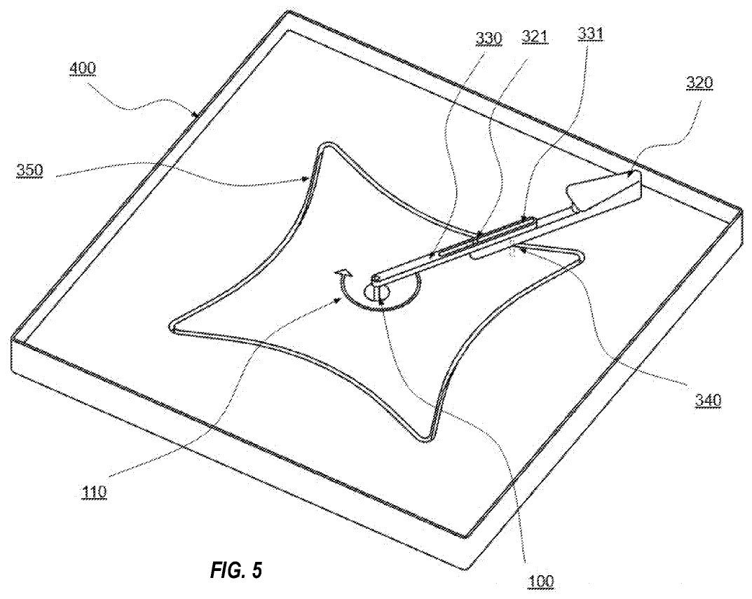

As discussed above, one example application of the device described above is a fan that sweeps out a rectangular area, for example, for use with a rectangular shaped duct, a computer cooling fan, a window fan, etc. FIGS. 6A-6F are diagrammatic representations of the motion of an embodiment of a square fan using the present method. FIGS. 6A-6F show a square fan 600 at various angular positions. In this example, four armatures (similar to the armatures described above with respect to FIG. 5) are coupled to a source of rotational motion. In this exemplary implementation, four fan blades 620 are each attached to a movable outer armature portion (see FIG. 5). As the fan blades 620 rotate counterclockwise (as sequentially illustrated in FIGS. 6A-6F), the fan blades extend or retract in response to their respective bearings (e.g., bearing 340 shown in FIG. 5) riding within the guiding track 650. In this example, each of the bearings for all of the armatures can ride within the same guiding track 350.

FIG. 6A shows the fan blades 620 at their shortest positions, which corresponds to the bearings being positioned at the most inward portions of the guiding track 650. As the fan blades 620 rotate slightly counterclockwise (FIG. 6B), the fan blades are slightly extended, approximately matching the desired square shape of non-circular motion. Similarly, as the fan blades 620 rotate further counterclockwise (FIG. 6C), the fan blades are extended further. As the fan blades 620 rotate further counterclockwise (approximately 45 degrees from the position of FIG. 6A), they reach their most extended position (FIG. 6D), which corresponds to the bearings being positioned at the most outward portions of the guiding track 650. As the fan blades 620 continue rotating counterclockwise, their lengths begin to retract (FIGS. 6E, 6F), and so on. It can therefore be seen that, as the fan blades (or other components coupled to the armature(s)) rotate, their lengths will adjust according to the desired non-circular rotational path, which in the example of FIGS. 6A-6F approximates a square.

One notable advantage of this implementation is that opposing fan blades 620 have approximately identical lengths, which prevents any shift in the center of mass of the combined system. It should be clear to one skilled in the art how this can be extended to other embodiments that have more or fewer armatures and how to follow different non-circular patterns. One skilled in the art will also understand how the tops of the fan blades follow the perimeter of the shape being swept, extending and retracting along the sliding joint of the two armatures, so that in the position shown in FIG. 6D, for example, the blades extend all the way from the center to the edges, as well as how to attach different functional components other than fan blades to the armatures to accomplish different tasks.

It is also evident from the figures that the shapes of the fan blades can be selected to achieve desired results. For example, referring to FIG. 6D, it can be seen that fan blades with a pointed end could reach farther into corners than fan blades with flat ends. Therefore, a designer can configure the shapes of fan blades (or other components) as desired. Similarly, a designer can use any desired number of armatures. While FIG. 5 shows one armature and FIGS. 6A-6F show four armatures, devices can be designed with other numbers (e.g., two, three, five, six, etc.). One consideration, though, is that, depending on the application, weight, speed, etc., factors such as weight balancing may need to be considered. For example, as armature weights and speeds increase, it becomes more important to keep the armatures balanced, to reduce vibration. Besides designing rotational paths and armature configurations that maintain a desired balance, a designer may also use counter weights or other techniques to maintain a desired balance.

In the examples discussed above with respect to FIGS. 5-6, the armature lengths are adjusted mechanically via a bearing following the shape of a guiding track. In another example, the armature lengths can be controlled via an actuator and corresponding controller. For example, a two part armature, similar to those described above, comprises an outer armature portion, which can move radially relative to an inner armature portion. In this example, an actuator (e.g., an electric motor in combination with a mechanism to move the inner and outer armatures relative to one another) is coupled to the armature and is controlled by a controller. As the armature rotates, the controller controls the length of the armature (via the actuator), resulting in the desired non-circular rotational path. For implementations with multiple armatures, the lengths of the armatures can be controlled identically, or uniquely, depending on the application and desired rotational path. Other mechanisms may be used to control the length of armatures, as one skilled in the art would understand.

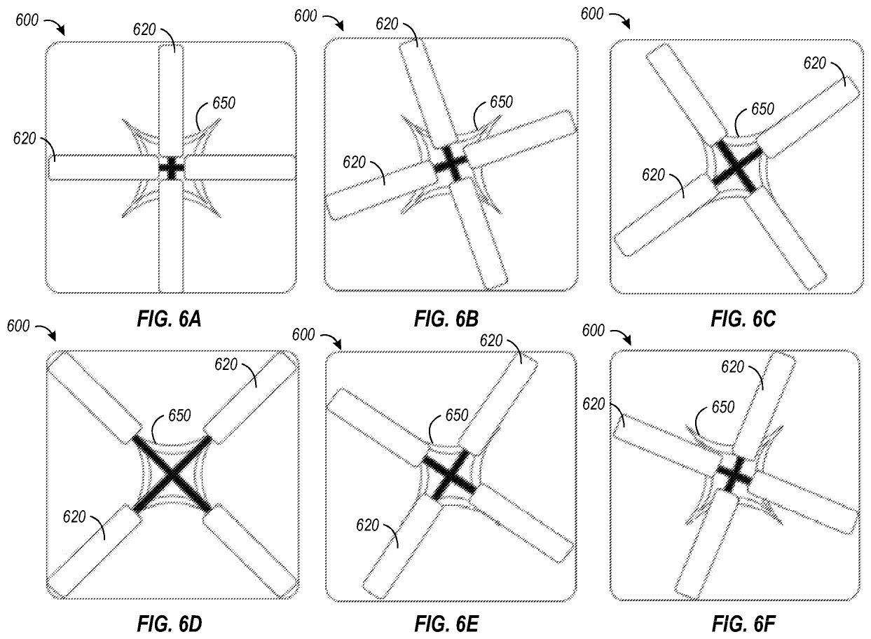

FIG. 7 is a block diagram depicting an armature(s) that is controlled via a controller and actuator(s). An actuator 722 is connected to the armature 720, and is capable of controlling the length of the armature 720, for example by causing an outer armature portion to move relatively to an inner armature portion. A controller 724 is connected to the actuator 722 to control the operation of the actuator 722. In some examples, the controller 724 can be a computer or microprocessor controlled controller, although any type of controller can be used, as one skilled in the art would understand. In this embodiment, the controller can be programmed to generate any desired non-circular rotational path, by causing the actuator to extend and retract the armatures at the desired rotational positions.

In embodiments using a controller to control the operation of a device, numerous options are available. For example, the speed of rotation and length of the armatures can be controlled in various manners. Input from sensors (e.g., temperature sensors, air/fluid density sensors, motion sensors, proximity sensors, etc.) can be used to dynamically control the rotational speed and/or armature lengths. For example, when controlling a fan, temperature sensors can be used in controlling the speed of the fan blades and/or the shape of the fan cross-section. In some examples, it may be desirable to adjust the rotational speed in response to the armature positions (e.g., reducing rotational speed when the armatures are extended outward, etc.). In applications such as sanding, cleaning, polishing, smoothing, etc., sensors can detect obstacles, and the controller can control the shape of the armature movements to help avoid the obstacles or more efficiently move around the obstacles.

As discussed above, a system and method that converts circular rotary motion into non-circular rotary motion has many applications. One application relates to power trowels (also known as “power floats,” “troweling machines,” etc.), which are used by construction workers to apply a smooth finish to concrete slabs. One problem with power trowels is that a slab of concrete typically has square corners, and commonly is surrounded by walls or other structures that prevent a conventional round power trowel from reaching the corners of the concrete slab.

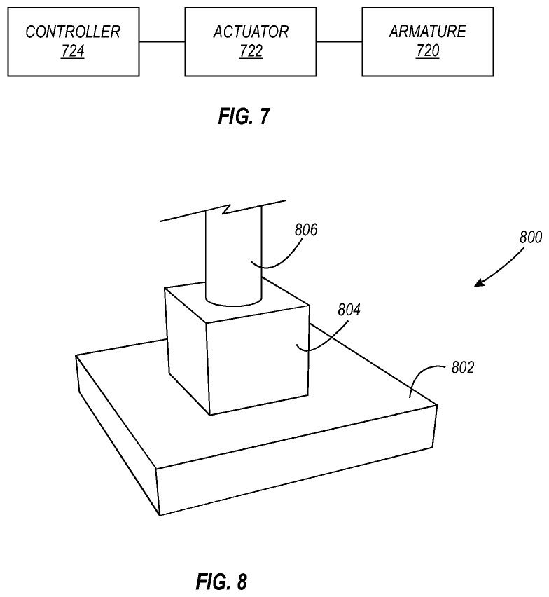

FIG. 8 is a simplified partial view of a power trowel utilizing the methods described above for converting circular rotary motion into non-circular rotary motion. FIG. 8 shows a power trowel 800 comprising a base unit 802, a prime mover (e.g., an engine or motor) 804, and connection/attachment member 806. The power trowel connection member 806 may be attached to the remainder of the power trowel, which could be a walk-behind power trowel, a ride-on power trowel, a remote controlled power trowel, a robotically controlled power trowel, etc. Note that typical ride-on power trowels have multiple blade units working together to cover a larger surface, and to provide more stable support for a rider. Other applications may also benefit from multiple armature sets working together.

The base unit 802 of the power trowel 800 may comprise a finishing blade unit (e.g., a plurality of trowel blades) enclosed by a guard unit (typically a cage-type of structure, which allows a user to view the trowel blades). From underneath, the base unit 802 may look similar to the square fan 600 shown in FIGS. 6A-6F, with the fan blades being replaced by trowel blades. The power trowel 800 operates like a conventional power trowel, except that the trowel blades move in a square rotational path, like the blades 620 shown in FIGS. 6A-6F. In this way, the power trowel 800 is capable of reaching corners of a concrete slab where a conventional round power trowel cannot not reach.

Although the invention has been described with respect to specific embodiments thereof, these embodiments are merely illustrative, and not restrictive of the invention. Rather, the description is intended to describe illustrative embodiments, features and functions in order to provide a person of ordinary skill in the art context to understand the invention without limiting the invention to any particularly described embodiment, feature or function, including any such embodiment feature or function described. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only to those elements but may include other elements not expressly listed or inherent to such process, product, article, or apparatus.

Additionally, any examples or illustrations given herein are not to be regarded in any way as restrictions on, limits to, or express definitions of, any term or terms with which they are utilized. Instead these examples or illustrations are to be regarded as being described with respect to one particular embodiment and as illustrative only. Those of ordinary skill in the art will appreciate that any term or terms with which these examples or illustrations are utilized encompass other embodiments as well as implementations and adaptations thereof which may or may not be given therewith or elsewhere in the specification and all such embodiments are intended to be included within the scope of that term or terms. Language designating such non-limiting examples and illustrations includes, but is not limited to: “for example,” for instance,” “e.g.,” “in one embodiment,” and the like.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the meaning of “in” includes “in” and “on” unless the context clearly dictates otherwise.

What is claimed is:

1. An apparatus for converting circular rotary motion into non-circular rotary motion comprising:
a rotatable shaft;
a first armature member coupled to the rotatable shaft;
a second armature member movably coupled to the first armature member, wherein the second armature member is radially movable along the first armature member;
a guide member disposed around the rotatable shaft defining a non-circular path; and
a bearing coupled to the second armature member, the bearing being configured to engage the guide member as the first and second armatures rotate with the rotatable shaft causing the second armature member to follow the non-circular path defined by the guide member.

2. The apparatus of claim 1, wherein the non-circular path has a generally rectangular shape.

3. The apparatus of claim 1, wherein the non-circular path has a generally square shape.

4. The apparatus of claim 1, wherein the non-circular path has a generally oval shape.

5. The apparatus of claim 1, wherein the non-circular path has a generally triangular shape.

6. The apparatus of claim 1, wherein the non-circular path has a generally hexagonal shape.

7. The apparatus of claim 1, wherein the non-circular path has a shape defined by a proper polar function.

8. The apparatus of claim 1, wherein the guide member comprises a track having inner and outer surfaces, and wherein the bearing is disposed between the inner and outer surfaces.

9. The apparatus of claim 1, further comprising a fan blade coupled to the second armature member.

10. The apparatus of claim 1, further comprising a trowel blade coupled to the second armature member.

11. The apparatus of claim 1, further comprising a plurality of sets of first and second armatures.

12. A method of converting circular rotary motion into non-circular rotary motion, the method comprising:
coupling a first armature member to a rotatable shaft;
movably coupling a second armature member to the first armature member, wherein the second armature member is radially movable along an axis of the first armature member;
rotating the first and second armature members; and
as the first and second armature members are rotated, adjusting the effective length of the first and second armature members to cause an end of the second armature member to move in a desired non-circular path.

13. The method of claim 12, wherein the non-circular path has a generally rectangular shape.

14. The method of claim 12, wherein the non-circular path has a generally square shape.

15. The method of claim 12, wherein the non-circular path has a generally oval shape.

16. The method of claim 11, wherein the non-circular path has a generally triangle shape.

17. The method of claim 11, wherein the non-circular path has a generally hexagon shape.

18. The method of claim 12, wherein adjusting the effective length of the first and second armature members by engaging a guide member defining a non-circular path with a bearing coupled to the second armature member.

19. The method of claim 12, wherein adjusting the effective length of the first and second armature members by controlling an actuator coupled to the first and second armatures.

20. The method of claim 12, further comprising coupling a fan blade to the second armature member.

21. The method of claim 12, further comprising a coupling trowel blade to the second armature member.

22. The method of claim 12, further comprising coupling a plurality of sets of first and second armatures to the rotatable shaft.

23. The method of claim 12, wherein the second armature is also movable in an axial direction relative to the plane of rotation of the first and second armatures, the method further comprising:
as the first and second armature members are rotated, moving the second armature in the axial direction.

24. An apparatus for converting circular rotary motion into non-circular rotary motion comprising:
a rotatable shaft;
a guide member disposed around the rotatable shaft defining a non-circular path;
a plurality of armature assemblies coupled to the rotatable shaft, wherein each of the armature assemblies further comprises:
a first armature member coupled to the rotatable shaft;
a second armature member movably coupled to the first armature member, wherein the second armature member is radially movable along the first armature member;
a bearing coupled to the second armature member, the bearing being configured to engage the guide member as the first and second armatures rotate with the rotatable shaft causing the second armature member to follow the non-circular path defined by the guide member; and
a plurality of functional components, each functional component coupled to the second armature member of one of the plurality of armature assemblies.

25. The apparatus of claim 24, wherein the plurality of functional components comprise fan blades.

26. The apparatus of claim 24, wherein the plurality of functional components comprise trowel blades.

27. The apparatus of claim 24, wherein the non-circular path has a generally rectangular shape.

28. The apparatus of claim 24, wherein the non-circular path has a generally square shape.
